(19) United States
(12) Patent Application Publication
(10) Pub. No.: US 2017/0215102 A1
(43) Pub. Date: Jul. 27, 2017

(54) Wireless Network Performance in Aggressive Interference

(71) Applicant: Microsoft Technology Licensing, LLC, Redmond, WA (US)

(72) Inventors: Amer Hassan, Kirkland, WA (US); Paul Mitchell, Seattle, WA (US); Aaron Cunningham, Redmond, WA (US); Mitesh Desai, Sammamish, WA (US)

(73) Assignee: Microsoft Technology Licensing, LLC, Redmond, WA (US)

(21) Appl. No.: 15/004,836

(22) Filed: Jan. 22, 2016

(51) Int. Cl. H04W 28/04; H04W 24/08

(52) U.S. Cl. CPC H04W 28/048; H04W 24/08

(57) ABSTRACT

Methods and apparatus are disclosed that provide a network that may determine the presence of it caused by an interfering system transmitting within the same frequency bands, or frequency bands closely adjacent to frequency bands, that the network is using, and initiate action to improve network performance in the presence of the interference. The presence of the interference may be determined by detecting that interference at a threshold level exists in the network, and determining that the detected interference is “aggressive” interference, i.e., caused by intentional transmissions from the interfering system in frequency bands in which the network is operating. Upon determination of the existence of aggressive interference, modifications to network wireless node behavior, for example to the transmission behavior of mobile wireless devices and wireless access points of the network, may be implemented to provide enhanced node operation that improves network performance in the presence of the aggressive interference.

### BACKGROUND

Because of large increases in mobile device use and the amount of mobile data traffic, wireless communications systems needing extra frequency bandwidth, such as long term evolution (LTE) systems, will soon begin to utilize channels within unlicensed frequency bands for transmissions. These mobile communications systems may utilize channels in the unlicensed bands in addition to or in place of channels in the officially assigned frequency bands. In most cases these unlicensed frequency bands have no requirements associated with them that restrict or coordinate the types of systems that may transmit on channels in these frequency bands.

Use of unlicensed frequencies by these systems may cause interference with other existing systems or networks that also transmit and receive on frequencies that happen to fall in the same unlicensed frequency band. For example, service providers have begun to implement LTE systems that may transmit on 5 GHz channels that are within frequency bands in the same unlicensed 5 GHz frequency band range as is specified by the IEEE 802.11 standard for use by Wi-Fi network transmission channels. Because the LIE systems transmit at high power levels and may grab onto and hold one or more channels in the 5 GHZ frequency range for long periods of time, the LIE networks may cause severe interference to the Wi-Fi networks. Also, because Wi-Fi networks currently operate using a feature that backs off packet transmissions in the presence of interference, the persistent interference from an LTE system may cause a Wi-Fi network to back off packet transmissions and remain backed off so that packet transmissions are substantially interfered with, and data throughput becomes unacceptable.

In general, the increasing use of different types of systems and networks, such as public and private Wi-Fi, wireless local area networks (WLANs), home media devices, LTE networks, etc., that use the same frequency bands or closely adjacent frequency bands has potential to increase interference levels and interfere with transmissions in co-existing systems and networks.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments of the disclosure provide a method and apparatus for a network that may determine the presence of interference caused by an interfering system that is transmitting within the same frequency bands as, or frequency bands closely adjacent to, the frequency bands that the network is using, and initiate action to improve network performance in the presence of the interference. The presence of the interference caused by the interfering system may be determined by detecting that interference at a certain threshold level exists in the network, and determining that the detected interference is “aggressive” interference, i.e., caused by intentional transmissions from the interfering system. Upon a determination of the existence of aggressive interference, modifications to network wireless node behavior, for example to the transmission/reception behavior of wireless devices and wireless access points of the network, may be implemented to provide enhanced wireless node operation that improves network performance in the presence of the aggressive interference, if it is determined that the aggressive interference has abated, for example if the interfering network stops transmitting on certain interfering frequency bands, the modified communication node behavior may be changed so the nodes operate with behavior as they did prior to the modifications.

In an embodiment, a controller in a Wi-Fi network may determine the presence of interference caused by an interfering system within the unlicensed frequency bands that the Wi-Fi network is using, and initiate action to improve Wi-Fi network performance in the presence of the interference. For example, the controller may determine the presence of interference caused by interfering system transmissions in unlicensed bands that interfere with transmissions on certain unlicensed channels used b the Wi-Fi network. The device may then initiate appropriate action in the network to improve network performance, such as initiating a change in client device or access point (AP) behavior to improve Wi-Fi performance in the interference environment. The controller may determine that the interference from the interfering system exists by detecting a trigger condition that indicates the presence of interference. The trigger condition may be any type of measurement, data, or device behavior that indicates that interference exists in the network. The controller may then determine that the interference is “aggressive” interference, i.e., caused by an interfering system that is intentionally using the frequency channels that cause the interference. The determination that the interference is aggressive may be used as an indication that the interference may be persistent and that action should be initiated to reduce the effects of the interference on the Wi-Fi network. In implementations, the determination that the interference is aggressive may be performed by estimating the aggressiveness of the interference using cognitive techniques, for example, by analyzing consistently encountered interference at particular measured threshold levels, or by analyzing interference having particular time windows or duty cycles. In another implementation the determination that the interference is aggressive may be performed by decoding enough of a transmission from the interfering system to determine that the interference is caused by a particular type of interfering system.

Upon detection of aggressive interference, the controller may initiate action to cause modifications to the Wi-Fi client device or AP behaviors that improve performance in the aggressive interference environment. During client device or AP operation with modified behavior the interference in the network may be reevaluated. If an increase in the aggressive interference has occurred, further modification to the client device or AP behaviors may be performed. If the interference is no longer aggressive the client device or AP behaviors may be changed so the devices operate with behavior as they did prior to the modifications. The changes to client device or AP behavior in a Wi-Fi network may include modifying the back off behavior of Wi-Fi packet transmission that is normally performed when interference is encountered in Wi-Fi. For example, this may be done by stopping back-off completely or reducing the amount of back off (e.g. using a linear instead of an exponential back off rate) for more aggressive Wi-Fi transmissions. In other implementations the changes to the Wi-Fi client device or AP behaviors in the presence of aggressive interference may include, for example, changes to media access control (MAC) layer behavior, for example, utilizing different MAC profiles to modify device behavior and transmissions, increasing forward error correction (FEC) coding, or disabling negative acknowledgement (NAK) for packet transmission. The various changes to client device or AP behavior may be done separately or in combination. The controller may control APs in the Wi-Fi network so that a “change mode” signal is sent in the AP beacon signals that are broadcast to client devices in the network to instruct the devices to initiate the appropriate action. In an embodiment in a network such as a Wi-Fi network the controller device may comprise a separately implemented device. In other implementations, portions of the functions of the controller device may be implemented in one device or node, or dispersed through more than one communication node, such as APs or wireless devices operating in the network.

### BRIEF DESCRIPTION OF THE DRAWINGS

FIG. 1 is a diagram illustrating a wireless network according to an embodiment of the disclosure;

FIG. 2 is a flow diagram showing example operations in a wireless network subject to aggressive interference;

FIG. 3A is a flow diagram showing another example of operations in a wireless network subject to aggressive interference;

FIG. 3B is a flow diagram showing example operations for determining a type of interference;

FIG. 3C is a flow diagram showing further example operations for determining a type of interference;

FIG. 4 is a simplified block diagram showing an example client device for use in aggressive interference;

FIG. 5 is a simplified block diagram showing an example access point in a wireless network subject to aggressive interference; and,

FIG. 6 is a simplified block diagram showing an example controller in a wireless network subject to aggressive interference.

### DETAILED DESCRIPTION

The system, method and apparatus will now be described by use of example embodiments. The example embodiments are presented in this disclosure for illustrative purposes, and not intended to be restrictive or limiting on the scope of the disclosure or the claims presented herein.

The technologies and techniques that are described herein provide embodiments of systems, methods and apparatus that allow a wireless network to operate with reduced performance degradation in the presence of interference generated by one or more interfering systems. The embodiments provide advantages through use of methods that allow determination of whether interference detected in a network is aggressive interference. If the interference is determined to be aggressive an action to change wireless node behavior in order to improve performance of the first network may be initiated.

The term “aggressive interference” as used in this disclosure means interference that is detected in a first network, where the interference is caused by a second interfering network or system, not part of the first network, and that is determined to meet other certain criteria that indicate the persistence and the intentionality of the second system in transmitting on the channels causing the interference. The channels on which the second system is transmitting may be in one or more frequency bands that overlap with, or are adjacent to, the frequency bands that include channels used by the first network. The criteria may be based on any measurements, parameters, or characteristics of the interference, or determined characteristics of the interfering system, that can be used to determine persistence and, intentionality of the interference. This includes measurements, parameters, or characteristics of the interference that may be detected by the first network or be made known to the first network.

The embodiments provide advantages in that detected interference may be determined as aggressive and action to change wireless node behavior may be performed based on the criteria met by the interference in the determination. For example, the various criteria may include the duty cycle, or the likely persistence or time duration of the interference. The criteria on which the determination of aggressive interference is based may also include characteristics of the detected type of interfering system, for example, the access protocols or physical layer of the interfering system. By basing the determination on various criteria, different types of interference in different situations may be accounted for, and action to change wireless node behavior may be initiated in appropriate interference situations. A particular action may be initiated for a particular interference situation. Action to change wireless node behavior may also be avoided when the action may not be appropriate. For example, initiation of action that is more conservative on spectrum sharing within the first network may be avoided in situations where interference is caused by internal network operation. In that case, other more appropriate actions may be taken.

Example implementations in which the embodiments provide technical advantages may be used in networks using carrier sense multiple access (CSMA) protocols, such as networks operating according to the IEEE 802.11 based protocols. In CSMA networks various techniques are utilized for avoiding collisions between transmissions of nodes operating in the network. Depending on the type of interference the network encounters, these collision avoidance techniques may be counterproductive. For example, transmission back-off behavior that may be useful in ensuring adequate throughput for data transmissions when multiple wireless nodes are interfering with one another, and contending for access to a network, may cause the network to become severely degraded in the presence of aggressive interference from an external system. For example, aggressive interference that is persistent may cause transmitting wireless nodes to back-off and stay backed-off, and access to the network may be severely affected. In these implementations, a determination of interference as aggressive allows back-off to be appropriately adjusted to avoid this situation. This technical advantage may be useful in a situation in which transmissions on unlicensed frequency bands within an 802.11 based network are being interfered with by LTE system transmissions on the same unlicensed bands.

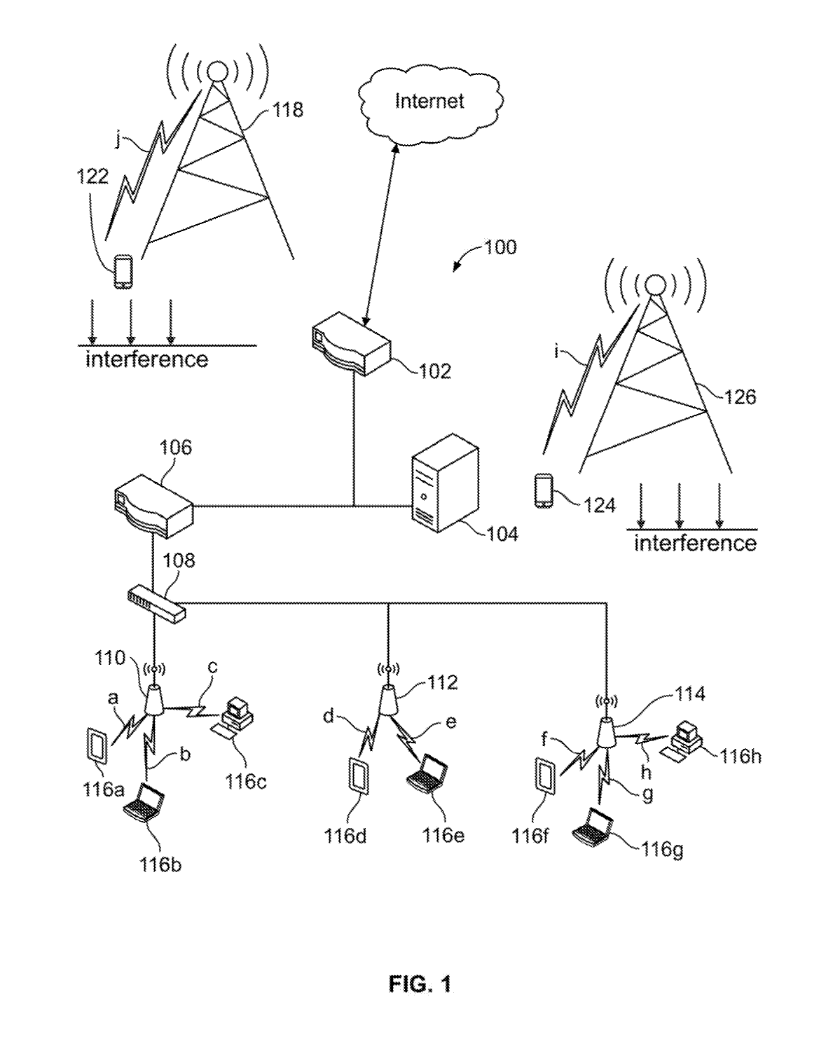

Referring now to FIG. 1, therein is a simplified diagram of an example network in which embodiments of improved network performance in aggressive interference according to the disclosure may be implemented. Network 100 may be, for example, a local area network (WLAN). A cellular system represented by base stations 118 and 126, and cellular mobile devices 122 and 124, may be located in an area adjacent, or near enough, to network 100 so that radio transmissions from the cellular system reach into the coverage area of network 100. Network 100 includes router 102, access point/gateway 106, controller 104, switch 108, and, wireless nodes, shown as network access points (APs) 110, 112, and, 114. Router 102, access point/gateway 106, controller 104, and switch 108 may be configured to provide traffic routing and switching functions for traffic to and from the access points 110, 112, and 114 over the infrastructure. Other wireless nodes shown as wireless devices 116a-116h, are illustrated as operating within the coverage area of network 100 and communicating with a nearby AP of APs 110, 112 or 114 over the communication links a-h. In the example implementation of FIG. 1, one or more of wireless devices 116a-116h may be dual mode and operable to communicate with both base stations 118 and 126 and with network 100. In this case network 100 may be used for data traffic of the dual mode devices from the cellular system when the dual mode devices are operating within the coverage area of network 100. In alternative embodiments network 100 may also support wireless devices 116a-116h that operate only in network 100. Network 100 may be a private business network, a commercial/retail establishment network, or any other type of wireless network.

Controller 104 is illustrated as single device or server but may be representative of any type of device or devices providing functions of a computing device that may be co-located or geographically dispersed. Controller 104 may also be located remotely from network 100. Also, while wireless devices 116a-116h are each shown as implemented as one of an example smart phone, a tablet computer, a desktop computer, or laptop computer device, each of the example wireless devices 116a-116h may be alternatively implemented as any other type of wireless node or device, or number of wireless nodes or devices, that may be configured with functionality supporting the embodiments disclosed herein. These other types of devices may include, for example, gaming devices, media devices, smart televisions, home theater systems, smart automobile systems, smart house systems, multimedia cable/television boxes, smart phone accessory devices, tablet accessory devices, personal digital assistants (PDAs), portable media players, smart sensors, smart watches, or industrial control systems.

In an example implementation, network 100 may operate over a range of frequencies on communication links a-h according to IEEE 802.11 standards specifications. The frequency range may include frequency bands in the range of 300 MHz to 90 GHz, each according to the 802.11 specification for the particular frequency band. For example, network 100 may include access points 110-114 that each include transceivers operable according to one or more of the 802.11a (5 GHz), 802.11b (2.4 GHz), 802.11g (2.4 GHz), 802.11n (2.4/5 GHz), 802.11ac (5 GHz), 802.11ad (60 GHz), 802.11af (54-698 MHz (TVWS)), or 802.11ah (0.9 GHz (HaLow)) standards.

in alternative example implementations, network 100 may also operate over any other electromagnetic frequencies, including optical wavelengths, or communication medium, and may include transceivers according to any other standards specifications, including any non-802.11 packet/framing protocols.

Wireless devices 116a-116h may each also be operable to communicate with the network APs 110-114 according to one or more of the IEEE 802.11 standards specifications on which the access point operates. Wireless devices 116a-116h may each include one or more applications that communicate data traffic with one of access points 110-114 when in the coverage area of network 100. These applications may include any type of application communicating over network 100, such as client applications communicating with a client application on another device in network 100, or in another network, applications included in the device operating system, applications installed or downloaded to the wireless device 116a-116h by a user, or any other type of function that communicates through network 100. Wireless devices 116a-116h may also include devices communicating directly over a wireless interface with one or more other devices without using APs 110-114. These devices may include one or more applications communicating over a wireless interface directly with applications in other devices such as, for example, peer to peer or device to device applications. These applications communicating directly with other devices could include, for example, devices using the 802.11 2.4 GHz Wi-Fi direct standard for a direct device to device connection.

An example scenario in which implementations of improved network performance in aggressive interference may be utilized is a scenario in which the cellular system that includes base stations 118 and 126 is configured to utilize LTE-U frequency band channels in the 5 GHz band that is used by network 100. Other example scenarios include scenarios in which network 100 utilizes transmissions in a TV WS frequency band. In the case in which network 100 may be utilizing TVWS frequency bands, other systems/networks are also allowed to use the same TVWS bands, and may cause aggressive interference in network 100. Implementations of improved network performance in aggressive interference may also be utilized in any other scenario in which the transmissions of a first network are consistently interfered with by aggressive interference from one or more second systems or networks.

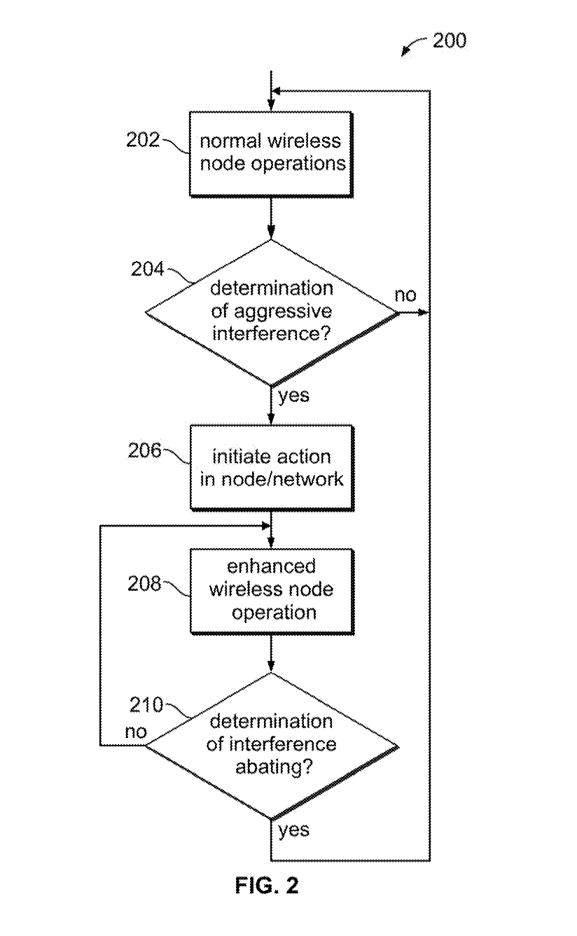

Referring now to FIG. 2, therein is a flow diagram 200 showing example operations in a wireless network subject to aggressive interference according to an embodiment. The process begins at 202 where network wireless communication nodes, such as wireless devices in a network coverage area, and APs, operate normally, i.e., operate without any modifications currently implemented by the process to improve performance in aggressive interference.

At 204 a determination of aggressive interference is performed. If the interference is determined to not be aggressive the process returns to 202. If the interference is determined to be aggressive the process moves to 206. The determination of aggressiveness at 204 may by performed by first detecting that interference at a certain threshold level exists in the network, and then determining that the detected interference is “aggressive” interference, i.e., caused by persistent and/or intentional transmissions from the interfering system. For example, the determination at 204 may be performed by detecting interference where the threshold level far interference is a parameter such as a signal to noise ratio (SNR), bit error rate (BER), packer error rate (PER), or a back-off parameter currently being used in a contention based access network. The threshold level may be chosen to be at a level at which the network operator has determined that network transmission quality and throughput become unacceptable. The process may be implemented so that the possibility of external interfering systems causing the interference may be checked when interference reaches the threshold level. The threshold level may be an average value and may be obtained from measurements or data collected at one or more of the network's wireless communication nodes. In some example implementations the threshold level may also be used in the determination as to whether the detected interference is aggressive interference. In another implementation the network may include a dedicated device for collecting the measurements of data from the viewpoint/location of a wireless device or AP.

When interference is detected it may then be determined if the detected interference is aggressive interference. The determination as to whether the interference is aggressive may include performing a determination as to whether the detected interference is caused by an interfering external system or network. In some implementations the identity of the technology type of an interfering system may be identified as part of the determination. The determination of aggressive interference may include cognitive analysis of interfering signals. For example, the duty cycle of interfering signals may be measured and used as a metric indicating the aggressiveness of the interference from an interfering system. In another example, an attempt to decode an interfering signal may be performed within the network to identify the type of interfering system or interfering system. The network may include devices with transceivers configured to attempt decoding of unknown signals based on knowledge of the protocols and technology used by potentially interfering network. An identification of the type of interfering signals may be used as a metric indicating the aggressiveness of the interference from an interfering system. For example, if the interfering system is identified as a system that may cause interference by persistently transmitting on channels in frequency bands that network 100 is using, the interference may be determined to be aggressive. An example of this would be identifying the interfering system as an LTE system transmitting on channels in the 5 GHz band. In this case the LTE transmissions would overlap with the frequency bands used by network 100, if network 100 was operating in the 5 GHz bands utilized by 802.11a 802.11n or 802.11ac devices. In another example, if it was determined from analysis or identification that an interfering system was an LTE system using channels in the 5 GHz band, but the LTE system was utilizing specially configured transmission schemes to reduce interference caused to other networks in the 5 GHz band, that determination may be used as a factor in deciding whether the interference is aggressive.

In other example implementations the determination of whether the interference is aggressive may include use of any of one or more parameters that allow a reliable estimation that an interfering network is causing the interference. For example, analysis for determining aggressive interference may include determining that data packet retransmissions have exceeded a predetermined number of retransmissions. Analysis may also include determining that measured data throughput in the network has been reduced by a significant percentage amount, for example In this case, the reduced data throughput may be compared to a previously measured data throughput in one or more areas of the network. The value of x % may be a value that is experimentally, or otherwise, derived and set to allow a reliable estimation by analysis that an interfering network is causing the interference. Other examples of analysis for determining aggressive interference may include determining that a packet error rate exceeds a predetermined value, for example a value of y %. In this case the value y % may be experimentally, or otherwise, derived and set to allow a reliable estimation that an interfering network is causing the packet error rate increase. Further examples of analysis for determining aggressive interference may include determining that a power measurement, for example a received signal strength indicator (RSSI), is above a predetermined level that has been derived to allow a reliable estimation that an interfering network is causing a high power measurement level. Other example implementations may include determinations involving combinations of two or more parameters, for example, determining that RSSI is above a predetermined level and that packet error rate exceeds y %, where the predetermined level of RSSI and packet error rate of y % are set to relative levels that have been derived to provide a reliable estimation that an interfering network is causing the interference.

In other implementations a database that includes available information on neighboring systems may also be accessed as part of the determination at 204. The information on neighboring systems may be information created and stored during previous determinations or information input to the database by other means. The information may include neighboring system capabilities, protocols or other information appropriate fur use in a determination of whether interference may be aggressive.

At 206, upon a determination of the existence of aggressive interference, the process initiates action in the wireless nodes of the network. The actions may include implementing modifications to network wireless node behavior with appropriate signal exchanges. For example, the transmission/reception behavior of wireless devices and access points of the network may be modified to provide modified/enhanced operation that improves network performance in the presence of the aggressive interference. The modifications to wireless node behavior may include, for example, modifying media access control (MAC) layer behavior such as back-off to be conservative on spectrum sharing, for example by using a scheme such as a carrier sense multiple access (CSMA) scheme with low delay exponential back-off, linear back-off, or no back-off. Another implementation may include a CSMA scheme with a point coordination function (PCF) or hybrid coordination function controlled channel access (HCCA) mode enabled to give priority to one device over another, or enabled to adjust its scheduling mechanism to account for higher or lower levels of aggressive interference. The PCF/HCCA mode may be disabled when aggressive interference is no longer present. The modifications to CSMA behavior may be configured according to the aggressive external network interference.

The modifications to wireless node behavior may also include increasing forward error correction (FEC) coding. Because FEC may be configured for intra-network as well as external (inter-network or heterogonous) network interference, an FEC profile may normally be selected to achieve a retries threshold (impacting delays) and packet error rate (PER) threshold. Increased error protection may be configured using FEC when aggressive interference is present and transmission quality is impacted. Other modifications may include, for example, disabling negative acknowledgement (NAK) for packet transmission in the presence of aggressive interference. The various changes to wireless node behavior, such as client device behavior, or AP behavior, may be done separately or in combination. In one example, a controller may control APs in a Wi-Fi network so that a “change mode” signal is sent in the AP beacon signals that are broadcast to client devices in the network to instruct the devices to initiate the appropriate action.

Next, at 208, the network operates using enhanced wireless node/network operation with wireless node behavior as modified in operation 206. In an implementation, after a predetermined time period, or upon another triggering, event, a determination may be made at 210 as to whether the aggressive interference has abated, i.e., has disappeared or fallen to an acceptable level. If the aggressive interference has abated the process may move back to 202 and resume operation with communication node behavior as prior to the determination of aggressive interference. If the aggressive interference has not abated the process may continue the enhanced wireless node/network operation of 208. In implementations, the operation at 208 may also include monitoring the aggressive interference and initiating further modifications to wireless node behavior if the aggressive interference increases to improve network performance in the increased interference. Implementations may also include monitoring the aggressive interference and initiating further modifications to wireless node behavior if the aggressive interference decreases but remains at an unacceptable level, to improve overall network performance in the decreased aggressive interference.

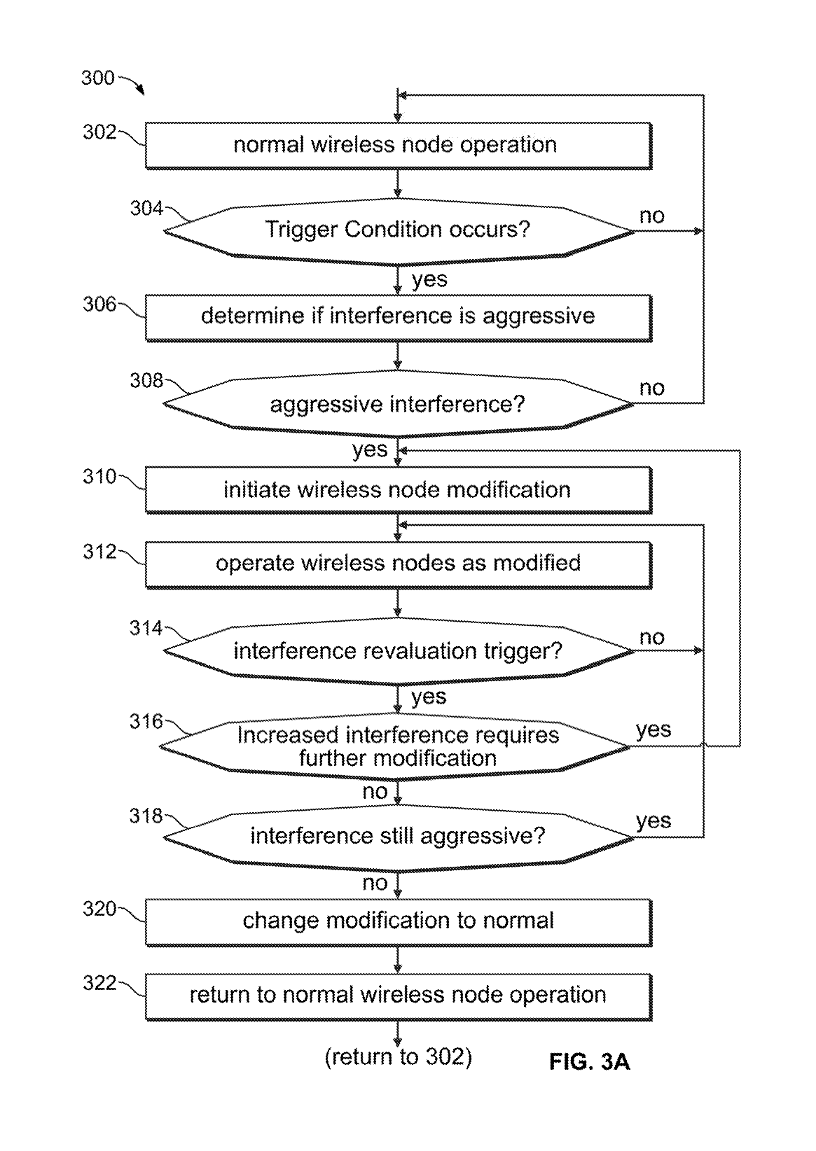

Referring now to FIG. 3, therein is a flow diagram 300 showing another example of operations in a wireless network subject to aggressive interference. FIG. 3 shows an example implementation that may be described with reference to network 100 of FIG. 1 as an example Wi-Fi network having controller 104, and wireless nodes implemented as network APs 110-114 and wireless devices 116a-116h. Also, FIG. 3 maybe described using an example scenario in which base stations 118 and 126, and, mobile devices 122 and 124 comprise infrastructure and devices of a LTE system in proximity to network 100. In the example scenario the LIE system may be capable of utilizing channels in the unlicensed 5 GHz frequency bands to generate aggressive interference in Wi-Fi network 100.

The process begins at 302 where wireless devices 166a-116h and APS 110-114 in network 100 operate with normal device behavior, i.e., operate without behavior modified for detected aggressive interference. At 304, during network operation, controller 104 may perform a determination as to whether a trigger condition has occurred. Controller 104 may make the determination at 304 at predetermined times or may constantly monitor network operation for the trigger condition. Controller 104 may receive data generated within network 100, such as operating data from one or more of wireless devices 166a-116h and APS 110-114 to use in making the determination. The trigger condition may be triggered, for example, when one or more Wi-Fi back-off parameters have reached a selected level. For example, if one or more of wireless devices 116a-116h or APS 110-114 perform back-off of transmissions on average more than a selected amount of times during a selected time period, the trigger condition may occur. In another example, if the average back-off delay of one or more of wireless devices 116a-116h increases above a selected delay the trigger condition may occur. Any combination of parameters that are affected by interference may be used as the trigger condition. In alternative embodiments, the determination of the trigger condition occurring may be based on any other suitable criteria for detecting interference. For example, controller 104 may receive and monitor parameters, such as the parameters of SNR, BER, or PER described in relation to 204 of FIG. 2.

If it is determined that a trigger condition has not occurred, the process moves back to 302 and normal device operation continues until another determination is made at 304. If it is determined that a trigger condition has been met the process moves to 306.

At 306 controlled 04 determines whether the interference that caused the trigger condition to be met is aggressive interference. Controller 104 may instruct one or more of wireless devices 166a-116h and APS 110-114A to perform measurements and generate data used in the determination. The determination that the interference is aggressive may include determining criteria that the interference is from an LIE system operating in the same or adjacent band is met. In the example scenario, the determination may be made, for example, as shown in FIG. 3B. In the process of FIG. 3B, at 330, controller 104 may instruct one or more of wireless devices 166a-116h and APS 110-114A to attempt to at least partially decode an interfering signal to determine if it is an LTE signal. At 332 controller 104 determines if the interfering signal was sufficiently decoded to indicate that the interference is aggressive, i.e., from the LTE system operating in the same or adjacent band, and generates a result at either 334, indicating aggressive interference, or at 336, indicating no aggressive interference. In another implementation of the example scenario shown in FIG. 3C, at 338, controller 104 applies cognitive analysis to the interference to attempt to identify the type of system that generates the interference. One example of applying cognitive analysis is measuring the duty cycle of an interfering signal to determine if the interfering signal exhibits characteristics of an LTE signal awl is from the LTE system operating in the same or adjacent band. At 340 the process determines if the analysis indicates the interference is aggressive, i.e., from the LTE system and generates a result at either 342, indicating aggressive interference, or at 344, indicating no aggressive interference. In other example implementations any type of criteria, metric, or measure that indicates the aggressiveness of the interference may be used in the determination at 306 by controller 104. One or more of wireless devices 116a-116h and/or APs 110-114, or a dedicated measurement device implemented in network 100, may include transceivers configured to measure or decode the interfering signals and send the results to controller 104.

If it is determined, at 306, that the interference is not aggressive the process moves back to 302 and wireless devices 166a-116h and APS 110-114 in network 100 operate with normal device behavior, i.e., operate without behavior modified for detected aggressive interference. If it is determined, at 306, that the interference is aggressive the process moves to 310.

At 310 actions to initiate modification of the behavior of wireless devices 166a-116h and APS 110-114 begin in, network 100. Controller 104 may instruct APs 110-114 to modify back-off behavior. APs 110-114 may also be instructed by controller 104 to relay instructions to wireless devices 116a-116h to modify back-off behavior accordingly. The modifications to back-off behavior may include lowering the delay of a currently used exponential back-off, changing a currently used exponential back-off to a linear back-off, or shutting off a currently used back-off so no back-off is used by APs 110-114 or wireless devices 116a-116h. The modifications may be configured for the example scenario of aggressive interference in the same or adjacent band to cause wireless devices 116a-116h and APs 110-114 to operate more conservatively as regards sharing spectrum. In other example implementations, different types of modifications may be used depending on the criteria that were met in the determination of aggressive interference. For example, if it was determined at 308 that the LTE system was utilizing specially configured transmission schemes to reduce interference caused to other networks in the unlicensed band when it was using the same or adjacent band, the modifications to wireless node behavior may be less conservative with spectrum sharing. In alternative embodiments the modifications to back-off behavior may include modifications to the currently used FEC scheme to increase error protection, or disabling NAK, as described in 206 of FIG. 2. Also, the various changes to wireless node behavior, such as client device behavior, or AP behavior, may be performed separately or in combination, for example back-off behavior and FEC may both be modified. As part Of operation 310, the receipt of the modification instructions may be confirmed by APs 110-114 and wireless devices 116a-116h sending a confirmation indication to controller 104.

Next the process moves to 312 where APs 110-114 and wireless devices 116a-116h operate with behavior as modified for aggressive interference. After a predetermined time period, or upon the occurrence of another event, controller 104 may make a determination, at 314, as to whether an interference reevaluation has been triggered. If an interference reevaluation has not been triggered the process moves back to 312. If an interference reevaluation trigger has occurred the process moves to 316. At 316, controller 104 determines whether the aggressive interference has increased and if further wireless node modification is necessary. Controller 104 may perform the determination at 316 by monitoring the performance and quality of transmissions in network 100. If performance and quality has worsened since the previous wireless node modification at 310, the process may return to 310 where further modifications may be made. If it determined that the aggressive interference has not increased the process moves to 318.

At 318, controller 104 determines whether the interference is still aggressive. The determination at 318 may utilize the same methods as used in operation 308. If it is determined that the interference is still aggressive the process returns to 312 where modified operation of APs 110-114 and wireless devices 116a-116h continues. If it is determined that the interference is no longer aggressive the process moves to 320. At 320, controller 104 instructs APs 110-114 to change back-off behavior to normal back-off behavior as was used at 302. APs 110-114 may also be instructed by controller 104 to relay instructions to wireless devices 116a-116h to change back-off behavior to normal back-off behavior as was used at 302. The process then moves to 322 where APs 110-114 and wireless devices 116a-116h return to normal operation. The process then moves back to 302.

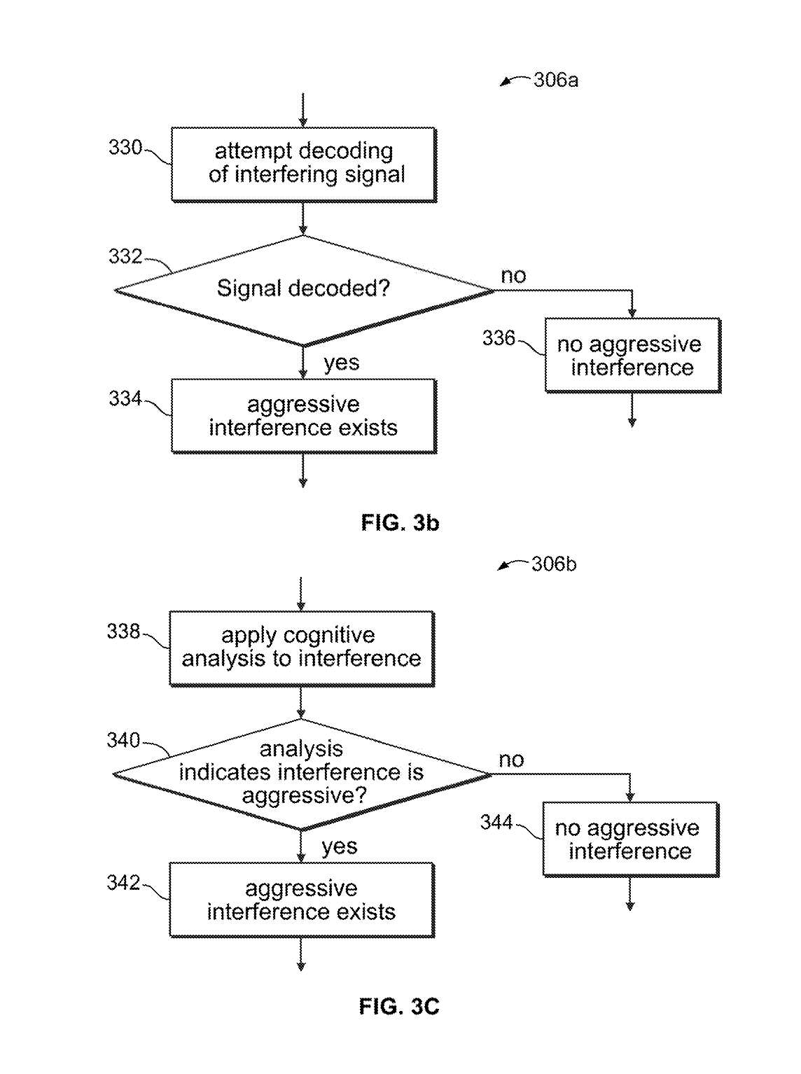

Referring now to FIG. 4, therein is a simplified block diagram of an example wireless communication node 400 which may be implemented in network 100 to operate according to FIGS. 2 and 3. Node 400 represents a possible implementation of any of wireless devices 116a-116h or any other device that may operate in a network, such as network 100, according to the embodiments of the disclosure. Node 400 may include user interfaces (UIs) 410 which may include any type of interface, for example, a touch screen/keypad, microphone, speaker or camera which receive inputs and provide outputs to and from node 400. Node 400 includes processor 408 and memory 412 which is shown as including program code or instructions for interference detection/control programs 418 that perform functions according to the embodiments. Processor 408 may comprise one or more processors, or other control circuitry or, any circuit or combination of processors and control circuitry that provide overall control of node 400 according to the disclosed embodiments. Memory 412 may be implemented as any type of computer readable storage media in node 400, including non-volatile and volatile memory. Memory 412 also includes OS programs 414 in the form of code for running the operating system to control the operations of node 400 and application programs 416. Memory 412 also may include data such as media data, camera photos and videos, contact data, calendar data, and other files used in the operation of applications on device. Processor 408 provides overall control of wireless node 400 and the other functional blocks shown in FIG. 4 by executing instructions and code in memory 412 to implement communications with other wireless nodes and control devices, and provide functions for operation in network 100.

In the example of FIG. 4, node 400 includes transceivers 402 that may comprise one or more transceivers configured to operate in different example frequency bands. For example, Transceivers 402 may comprise transceivers configured to communicate with APs 110-114 on channels in the 60 GHz Band, 2.4 GHz, 5 GHz Band, 300 MHz Band, 54-698 MHz TVWS Band, 0.9 GHz band, and cellular band TRX. In the embodiments device 600 and its transceivers may be operable to use one or more spectrum allocations that are allowed in each of the designated frequency bands according to the any relevant IEEE 802.11 or any other standard specifications supported by network 100. Also, transceivers 402 may use currently available TVWS channels according to requirements and regulations of the geographic area in which network 100 operates. Transceivers 402 may also be configured to allow device 400 to operate in a cellular system, such as an LTE system.

In an implementation, execution of interference detection/control programs 418 causes processor 408 to perform operations that cause functions of node 400 to perform appropriate operations according to FIGS. 2 or 3 in network 100. Processor 408 may also control node 400 to measure interference data, such as interference levels or error rates or measure/generate other parameter data and send the data to controller 104 for use in improving network performance in aggressive interference.

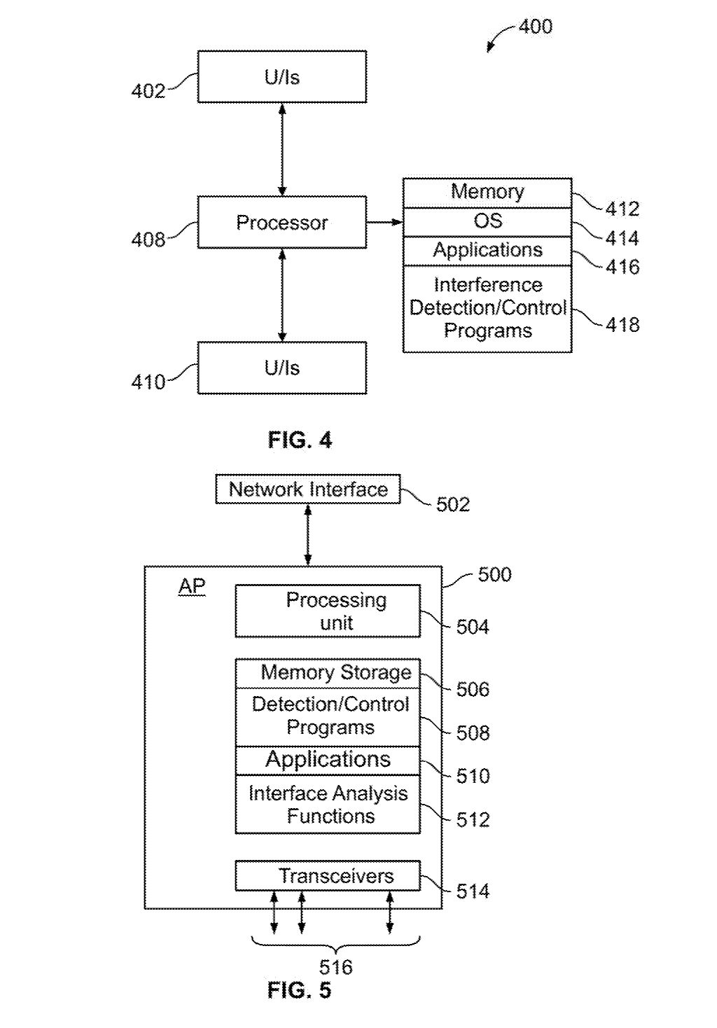

Referring now to FIG. 5, therein is a simplified block diagram of an example wireless node 500 which may be implemented in the network 100 to perform operations according to FIGS. 2 and 3. Node 500 may be implemented as any one or more of APs 110-116 of network 100. Node 500 includes processing unit 504, transceivers 516, and memory/storage 506 that includes code and instructions for interference detection/control programs 508 and applications 510. Memory 506 may be implemented as any type of as any type of computer readable storage media, including non-volatile and volatile memory. Node 500 connects to a backend network over network interface 502. Processing unit 504 may comprise one or more processors, or other control circuitry or any combination of processors, circuits, and control circuitry that provide overall control of the access point according to the disclosed embodiments. Transceivers 516 provide the capability for network 100 to communicate with wireless nodes, such as wireless devices 118-128, over RE channels according to network protocols of network 100. Processing unit 504 provides overall control of wireless node 500 and the other functional blocks shown in FIG. 5 by executing instructions and code in memory 506 to implement communications with other wireless nodes and control devices, and provide functions for operation in network 100

In an implementation, execution of interference detection/control programs 50$ causes processing unit 504 to perform operations that cause functions of node 500 to perform appropriate operations according to FIGS. 2 or 3. Processing unit 504 may also control node 500 to measure interference data, such as interference levels or error rates, or measure/generate other parameter data and send the data to server 104 for use in improving network performance in aggressive interference. In one alternative implementation, processing unit 504 and Interference Detection/Control Programs 508 may be configured to include a controller device similar to controller 104 in one or more APs 110-116 of network 100 to provide the functions provided by controller 104 without implementing a separate controller, such as controller 104, as shown in FIG. 1. In this alternative implementation memory 506 may include interference analysis functions 512 that, when executed, cause processing unit 504 to determine whether detected interference is aggressive.

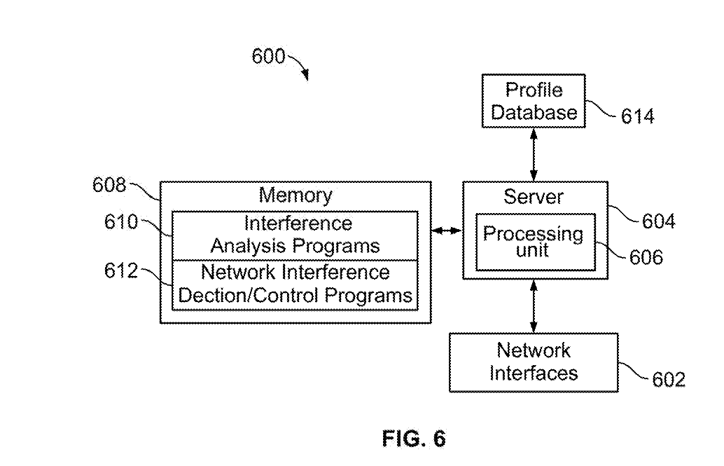

Referring now to FIG. 6, therein is a simplified block diagram of an example device 600 which may be implemented in the network 100 to perform operations according to FIGS. 2 and 3. For example, controller 104 of FIG. 1 may be implemented according to device 600 of FIG. 6. Device 600 may include a server 604 having processing unit 606, a memory 608, network interfaces 602, and data base 614. Memory 608 may be implemented as any type of computer readable storage media, including non-volatile and volatile memory. Memory 608 is shown as including interference analysis programs 610 and network interference detection/control programs 612. Server 604 and processing unit 606 may comprise one or more processors, circuits, or other control circuitry, or any combination of processors and control circuitry that provide overall control of device 600 according to the disclosed embodiments.

Network interference detection/control programs 612, when executed, cause the processing unit 606 to control server 604 to perform operations as shown in FIGS. 2 and 3. Device 600 may communicate through network interfaces 602 and receive data such as interference levels or error rates, or other, measured/generated parameter data from measurement devices in network 100 such as wireless devices 116a-11h and/or APs 110-114 for use in improving network performance in aggressive interference. Interference analysis programs 610, when executed, may cause processing unit 606 to perform determinations as to whether detected interference is aggressive. In other implementations processing unit 606 may control server 604 to access database 614 and obtain data related to neighboring systems/networks that are in proximity to network 100 and that may generate aggressive interference in network 100. The data in database 614 may be any type of data related to neighboring networks/systems that may be used by processing unit in determining if detected interference is aggressive interference. For example, database 614 may include data such as neighboring network types, transmission power levels, capabilities for transmission in frequency bands that overlap frequency bands used by network 100, etc.

Device 600 is shown as including server 604 as a single server. However, server 604 may be representative of server functions or server systems provided by one or more servers or computing devices that may be co-located or geographically dispersed to implement device 600. The term server as used in this disclosure is used generally to include any computing devices or communications equipment, that maybe implemented to perform the network interference detection/control and interference analysis programs functions and processes. For example, in one embodiment device 600 may be implemented as a part of one or more of APs 110-114.

The example embodiments disclosed herein may be described in the general context of processor-executable code or instructions stored on memory that may comprise one or more computer readable storage media (e.g., tangible non-transitory computer-readable storage media such as memory 412, 506 or 608). As should be readily understood, the terms “computer-readable storage media” or “non-transitory computer-readable media” include the media for storing of data, code and program instructions, such as memory 412, 506 or 608, and do not include portions of the media for storing transitory propagated or modulated data communication signals. The term non-transitory computer readable media is used in this disclosure as comprising all computer-readable storage media, with the sole exception being a transitory, propagating signal All forms of tangible computer readable storage media are included in non-transitory computer readable storage media.

Embodiments of Improved Network Performance in Aggressive Interference have been disclosed that include a device comprising one or more processors and memory in communication with the one or more processors, the memory including code, which when executed causes the one or more processors to determine that interference exists in a network, determine that the interference is aggressive, and initiate, based on at least the determining that that the interference is aggressive, an action modifying a behavior parameter of at least one node operating in the network. The code may be further executable to cause the one or more processors to determine that the interference is aggressive by causing the one or more processors to decode an interfering signal, and, the code may be still further executable to cause the one or more processors to determine that the interference is aggressive by causing the one or more processors to determine, based at least on the decoded signal, a type of interfering signal. The code may be further executable to cause the one or more processors to determine that the interference is aggressive by causing the one or more processors to apply cognitive analysis to an interfering signal, and, the code may be still further executable to cause the one or more processors to determine that the interference is aggressive by causing the one or more processors to determine, based at least on the cognitive analysis, a type of interfering signal. Also, the code may be further executable to cause the one or more processors to determine that the interference is aggressive by causing the one or more processors to determine that back-off behavior of the at least one node has satisfied a selected condition. The code may be still further executable to cause the one or more processors to determine that the interference is aggressive by causing the one or more processors to determine that a number of retransmissions has exceeded a predetermined number, or that throughput has been reduced by a predetermined amount, or that a packet error rate has exceeded a predetermined rate. Additionally the code may be further executable to cause the one or more processors to determine that the interference is aggressive by causing, the one or more processors to determine that that the packet error rate has exceeded the predetermined rate and that a received signal strength indicator has exceeded a predetermined power level. The code may also be further executable to cause the one or more processors to initiate an action by initiating an action to cause the one or more processors to modify a back-off parameter of the at least one node, or the code may be further executable to cause the one or more processors to initiate an action by initiating an action to cause the one or more processors to modify a negative acknowledgement behavior of the at least one node, or, the code may be further executable to cause the one or more processors to initiate an action by initiating an action to cause the one or more processors to modify a forward error correction behavior of the at least one node, or, still further, the code may be further executable to cause the one or more processors to initiate an action by initiating an action to cause the one or more processors to modify a MAC profile of the at least one node. The network may comprise a Wi-Fi network and the interference may comprise at least one LTE signal in the 5 GHz unlicensed band.

The embodiments also include a method comprising determining that interference exists in a network, determining that the interference is aggressive, and, initiating, based on at least the determining that that the interference is aggressive, an action modifying a behavior parameter of at least one node operating in the network. The determining that the interference is aggressive may comprise decoding an interfering signal, or, may comprise determining, based at least on the decoded signal, type of interfering signal, or, still further, may comprise applying cognitive analysis to an, interfering signal and may comprise, determining based at least on the cognitive analysis, a type of interfering signal. The determining that the interference is aggressive may comprise determining that a number of retransmissions has exceeded a predetermined number, or that throughput has been reduced by a predetermined amount, or that a packet error rate has exceeded a predetermined rate. Additionally, the determining that the interference is aggressive may comprise determining that that the packet error rate has exceeded the predetermined rate and that a received signal strength indicator has exceeded a predetermined power level. The initiating an action may comprise initiating an action to modify a MAC profile of the at least one node.

The embodiments also include a computer readable medium comprising instructions which when executed cause one or more processors to determine that interference exists in a network, determine that the interference is aggressive, and, initiate, based on at least the determining that that die interference is aggressive, an action modifying a behavior parameter of at least one node operating in the network. The instructions, further, when executed, may cause one or more processors to determine that the interfering signal is an LTE signal in the LTE-unlicensed band, or, the instructions, further, when executed, may cause the one or more processors to initiate an action by modifying a MAC profile of the at least one node.

While the functionality disclosed herein has been described by illustrative example using descriptions of the various components and devices of embodiments by referring to functional blocks and processors or processing units, controllers, and memory including instructions and code, the functions and processes of the embodiments may be implemented and performed using any type of processor, circuit, circuitry or combinations of processors and/or circuitry and code. This may include, at least in part, one or more hardware logic components. For example, and without limitation, illustrative types of hardware logic components that can be used include field programmable gate arrays (FPGAs), application specific integrated circuits (ASICs), application specific standard products (ASSPs), system-on-a-chip systems (SOCs), complex programmable logic devices (CPLDs), etc. Use of the term processor or processing unit in this disclosure is meant to include all such implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example embodiments, implementations, and forms of implementing the claims and these example configurations and arrangements may be changed significantly without departing from the scope of the present disclosure. Moreover, although the example embodiments have been illustrated with reference to particular elements and operations that facilitate the processes, these elements, and operations may be combined with, or be replaced by, any suitable devices, components, architecture, or process that achieves the intended functionality of the embodiment. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A device comprising:
one or more processors; and,
memory in communication with the one or more processors, the memory including code, which when executed causes the one or more processors to:
determine that interference exists in a network;
determine that the interference is aggressive; and,
initiate, based on at least the determining that that the interference is aggressive, an action modifying one or more behavior parameters of at least one node operating in the network.

2. The device of claim 1, wherein the code is further executable to cause the one or more processors to determine that the interference is aggressive by causing the one or more processors to decode an interfering signal.

3. The device of claim 2, wherein the code is further executable to cause the one or more processors to determine that the interference is aggressive by causing the one or more processors to determine, based at least on the decoding, a type of interfering signal.

4. The device of claim 1, wherein the code is further executable to cause the one or more processors to determine that the interference is aggressive by causing the one or more processors to apply cognitive analysis to an interfering signal.

5. The device of claim 4, wherein the code is further executable to cause the one or more processors to determine that the interference is aggressive by causing the one or more, processors to determine, based at least on the applying cognitive analysis, a type of interfering signal.

6. The device of claim 1, wherein the code is further executable to cause the one or more processors to determine that the interference is aggressive by causing the one or more processors to determine that back off behavior of the at least one node has satisfied a selected condition.

7. The device of claim 1, wherein the code is further executable to cause the one or more processors to determine that the interference is aggressive by causing the one or more processors to determine that a number of retransmissions has exceeded a predetermined number.

8. The device of claim 1, wherein the code is further executable to cause the one or more processors to determine that the interference is aggressive by causing the one or more processors to determine that throughput has been reduced by a predetermined amount.

9. The device of claim 1, wherein the code is further executable to cause the one or more processors to determine that the interference is aggressive by causing the one or more processors to determine that a packet error rate has exceeded a predetermined rate.

10. The device of claim 9, wherein the code is further executable to cause the one or more processors to determine that the interference is aggressive by causing the one or more processors to determine that that the packet error rate has exceeded the predetermined rate and that a received signal strength indicator has exceeded a predetermined power level.

11. The device of claim 1, wherein the code is further executable to cause the one or more processors to initiate an action by initiating an action to cause the one or more processors to modify a back-off parameter of the at least one node.

12. The device of claim 1, wherein the code is further executable to cause the one or more processors to initiate an action by initiating an action to cause the one or more processors to modify a negative acknowledgement behavior of the at least one node.

13. The device of claim 1, wherein the code is further executable to cause the one or more processors to initiate an action by initiating an action to cause the one or more processors to modify a forward error correction behavior of the at least one node.

14. The device of claim 1, wherein the code is further executable to cause the one or more processors to initiate an action by initiating an action to cause the one or more processors to modify a MAC profile of the at least one node.

15. The controller device of claim 1, wherein the network comprises a Wi-Fi network and the interference comprises at least one LTE signal in an unlicensed band.

16. A method comprising:
determining that interference exists in a network;
determining that the interference is aggressive; and,
initiating, based on at least the determining that that the interference is aggressive, an action modifying a behavior parameter of at least one node operating in the network.

17. The method of claim 16, wherein the determining that the interference is aggressive comprises decoding an interfering signal.

18. The method of claim 17, wherein the determining that the interference is aggressive comprises determining, based at least on the decoding, a type of interfering signal.

19. The method of claim 16, wherein determining that the interference is aggressive comprises applying cognitive analysis to an interfering signal.

20. The method of claim 19, wherein the determining that the interference is aggressive comprises determining, based at least on the applying the cognitive analysis, a type of interfering signal.

21. The method of claim 16, wherein the determining that the interference is aggressive comprises determining that a number of retransmissions has exceeded a predetermined number.

22. The method of claim 16, wherein the determining that the interference is aggressive comprises determining that throughput has been reduced by a predetermined amount.

23. The d method of claim 16, wherein the determining, that the interference is aggressive comprises determining that a packet error rate has exceeded a predetermined rate.

24. The method of claim 16, wherein the determining that the interference is aggressive comprises determining that that the packet error rate has exceeded the predetermined rate and that a received signal strength indicator has exceeded a predetermined power level.

25. The method of claim 16, wherein the initiating an action comprises initiating an action to modify a MAC profile of the at least one node.

26. Computer readable medium comprising instructions which when executed cause One or more processors to:
determine that interference exists in a network;
determine that the interference is aggressive; and,
initiate, based on at least the determining that that the interference is aggressive, an action modifying a behavior parameter of at least one node operating in the network.

27. The compute readable medium of claim 26, wherein the instructions, further, when executed, cause the one or more processors to determine that the interference is aggressive by determining a type of interfering signal in an unlicensed band.

28. The compute readable medium of claim 26, wherein the instructions, further, when executed, cause the one or more processors to initiate an action by modifying a MAC profile of the at least one node.
